(19) United States
(12) Patent Application Publication
(10) Pub. No.: US 2024/0169414 A1
(43) Pub. Date: May 23, 2024

(54) SMART MIRROR STYLING SYSTEM AND METHOD

(71) Applicants: Balisa Campbell, Broken Arrow, OK (US); Brooklyn Campbell, Broken Arrow, OK (US)

(72) Inventors: Balisa Campbell, Broken Arrow, OK (US); Brooklyn Campbell, Broken Arrow, OK (US)

(21) Appl. No.: 18/516,859

(22) Filed: Nov. 21, 2023

Related U.S. Application Data
(60) Provisional application No. 63/427,191, filed on Nov. 22, 2022.

(51) Int. Cl. G06Q 30/0601; G06V 10/70; G06V 40/16

(52) U.S. Cl. CPC G06Q 30/0631; G06Q 30/0621; G06Q 30/0643; G06V 10/70; G06V 40/174

(57) ABSTRACT

A smart mirror styling system and method. Illustrative embodiments may employ a camera with imaging algorithms capable of creating a multidimensional body mask of a person from the camera's data, the body mask comprising the person's size and shape. Artificial intelligent learning algorithms of the system correlate style preferences with user size and shape and other data to select stylish clothing items from a database to recommend clothing items that may be most appropriate for the person. The smart mirror system may then display scaled images of the selected clothing items on a mirror display, using the body mask, over a live image of the person from the system's cameras. The person may use the display to virtually “try on” the recommended clothing items. Clothing item recommendations may be determined using artificial intelligence algorithms.

### CROSS REFERENCE TO RELATED APPLICATIONS

This application claims the benefit of U.S. Application No. 63/427,191 to Balisa Campbell et al., filed Nov. 22, 2022 and entitled SMART MIRROR STYLING SYSTEM AND METHOD, which is hereby incorporated by reference in its entirety for all purposes, except to the extent that the incorporated material is inconsistent with the express disclosure herein, in which case the language in this disclosure controls.

### BACKGROUND OF THE INVENTION

### 1. Field of the Invention

The present disclosure generally relates to the fields of electronics hardware and computer science, and particularly for a smart mirror styling system and method. In particular, the disclosure provides a system and method for scanning body shape, matching articles of clothing to user measurements, and displaying a three-dimensional image of the user wearing the clothing on a smart mirror.

### 2. Description of the Related Art

Conventionally, shopping online for clothing is a difficult experience, particularly for women. Women's clothing sizes don't make sense and are not consistent in their measurements between brands. Shoppers are only able to view pictures of clothing worn by a model that inevitably has a different body shape and proportion than the shopper. Shoppers must rely on size charts that do not consider all aspects of body shape. It is currently estimated that shoppers return 40% of the clothing they buy online, often because the clothing does not fit or does not appear as the shopper anticipated.

Although certain forms of high-tech mirrors exist, they are typically designed for the home gym industry, such as for example, Lululemon's MIRROR. High-tech mirrors designed to improve exercise routines often display a recording or live video feed of an instructor carrying out a workout routine on a small portion of the mirror while the remainder of the device behaves as a conventional mirror. Some high-tech mirrors have the ability to connect to a heartrate monitor and include heartrate information on the mirror. Other high-tech mirrors are limited to displaying simple functions, such as weather or clock displays.

Some video games allow a user to control a virtual avatar to put on clothing but an avatar is generally not an accurate representation of the user. Trying clothing on with a virtual avatar could be just as frustrating as seeing a model wear clothing that will look much different when the user wears it.

Another problem in the fashion industry is that young people seeing the marketing of fashion may feel inadequate, have negative thinking patterns and unhealthy thoughts about themselves when comparing themselves to fashion models. The capability of a computer to identify negative emotions in an individual and provide an appropriate positive message would provide a benefit to the user.

As is apparent from the above, there currently does not exist hardware, software and algorithms that would allow three-dimensional shopping using a smart mirror try-on option. Therefore, there is a need for a smart mirror styling system and method.

### BRIEF SUMMARY OF THE INVENTION

The present disclosure provides a smart mirror styling system and method. An illustrative embodiment of a method of using a person's image in a smart mirror to recommend stylish clothing items to the person for purchase includes creating a multidimensional data mask of a person's image captured from one or more cameras of a smart mirror system, determining sizing data from the person's body shape and the person's body measurements using the multidimensional data mask, correlating the sizing data with a subset of clothing item entries in a database associated with the smart mirror system, and inputting the sizing data, the subset of clothing item entries from the database, the person's personal style preference data provided to the smart mirror system, and the data mask into an artificially intelligent (AI) algorithm running on a computer associated with the smart mirror system, wherein the AI algorithm selects clothing item entries which will best fit the person's size, shape and style, and displays the clothing item entries associated images, scaled dynamically to the multidimensional data mask for display on the smart mirror system such that the display allows the person to virtually try on the clothing items, interpreting the facial expression of the person to determine the person's opinion of the clothes, automatically selecting a different clothing item from the entries of clothing items and displaying the clothing item entry's associated images on the data mask to allow the person to virtually try on the clothing item if the facial expression correlates to a negative emotion and repeating interpreting and automatically selecting steps until a positive emotion is detected. In some embodiments the smart mirror system facilitates a purchase of the clothing items. In certain embodiments, interpreting the facial expression of the person comprises displaying an image that elicits a predicted emotional response from the user, recording the facial expression of the user associated with the emotional response, entering the response and correlated emotion into a database of responses, comparing the person's facial expression during clothing try on to the database of responses and identifying the emotion related to the facial expression.

An illustrative embodiment of a smart mirror system includes a computer, imaging software running on or associated with the computer, a touch-enabled smart mirror display coupled to the computer, one or more front-facing cameras coupled to the imaging software, a database of clothing items containing image, sizing and style data coupled to the computer, data about a person's personal preferences regarding clothing available to the computer, and an artificially intelligent learning algorithm able to select clothing items from a subset of clothing items in the database using a best clothing style for the person, the best clothing style based on the person's personal preferences, body shape and body size as determined by the imaging software and learned best choice styles as proscribed by data.

An illustrative embodiment of a smart closet function of a smart mirror system includes a database coupled to computer vision system providing an inventory system for creating a set of entries representing all items of clothing, fashion and accessories in a user's closet without requiring the user to input data about their wardrobe.

In various embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings in which:

FIG. 1A is a front view of a smart mirror of illustrative embodiments showing a reflection of a user wearing an exemplary virtual outfit and displaying a positive emotion.

FIG. 1B is a front of a smart mirror of illustrative embodiments showing a reflection of a user wearing an exemplary virtual outfit and displaying a negative emotion.

FIG. 1C is a back view of a smart mirror of illustrative embodiments.

FIG. 2 is a perspective view of a smart mirror system of illustrative embodiments in set-up mode.

FIG. 3 is a flow chart of a smart mirror facial recognition set-up method of illustrative embodiments.

FIG. 4 is a flow chart of a method of recommending clothing items of illustrative embodiments using an exemplary smart mirror.

While the invention is susceptible to various modifications and alternative forms, specific embodiments thereof are shown by way of example in the drawings and may herein be described in detail. The drawings may not be to scale. It should be understood, however, that the embodiments described herein and shown in the drawings are not intended to limit the invention to the particular form disclosed, but on the contrary, the intention is to cover all modifications, equivalents and alternatives falling within the scope of the present invention as defined by the appended claims.

### DETAILED DESCRIPTION

A smart mirror styling system and method is described. In the following exemplary detailed description, reference is made to the drawings. In the following description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

As used in this specification and the appended claims, the singular forms “a”, “an” and “the” include plural referents unless the context clearly dictates otherwise. Thus, for example, reference to a scan includes one or more scans.

As used in this specification and the appended claims, the terms “application,” “program, “computer program,” “software program” and “app” are used interchangeably. Any of these terms may refer to a self-contained software program installed on a device and designed to provide a consumer access to a function of illustrative embodiments.

As used in this specification and the appended claims, the terms “consumer”, “person” and “user” refer interchangeably to a person interfacing with illustrative embodiments via a smart mirror to learn about, virtually try on or purchase a product. A “user interface” refers to the display and/or sound output of information from a computer or smart mirror application.

As used in this specification and the appended claims, the terms “display,” “screen,” and “output,” may refer interchangeably to audio and/or visual information provided to a computer or mobile device user (consumer).

As used in this specification and the appended claims, the terms “twin reflection” and “data mask” are used interchangeably to refer to a computer-generated image of a user displayed on a screen.

As used in this specification and the appended claims, the term “mobile device” refers to any internet enabled electronic device.

As used in this specification and the appended claims, the terms “clothing” and “outfit” refer interchangeably to one or more items that may be worn by a user. Clothing may include, but is not limited to, shirts, belts, glasses, shoes, jewelry or other accessories.

As used in this specification and the appended claims, the term “twin reflection” refers to a computer-generated virtual likeness of a user. A twin reflection may not be identical to a user as a conventional reflection would be but rather, a twin reflection may differ from the user in hair color, clothing or similar physical feature or fashion item.

Illustrative embodiments may provide an artificial intelligence virtual styling, shopping and gaming mirror that may scan a person's image to determine body shape and size. This information may then be used to detect brands and/or articles of clothing and/or other accessories that match the user's measurements based on a search request, and allow the user to view how the clothing would fit on them in the mirror's “reflection” without the user actually trying on the outfit. Users may have the option to allow clothing to be populated automatically or to input search criteria to narrow the result possibilities to suit the user's needs. In some embodiments, the smart mirror of illustrative embodiments may include wardrobe scheduling abilities, esteem boosting abilities and/or a gamified shopping experience for example with brand partnerships. In some embodiments, the smart mirror of illustrative embodiments may have emotion detection capabilities and may select esteem boosting affirmations based on the emotion of the user that is detected. In some embodiments, the smart mirror may automatically change the clothing that is displayed on the user's image when a negative emotion is detected. Data regarding a user's preferences may be compiled to more accurately predict a user's preference going forward.

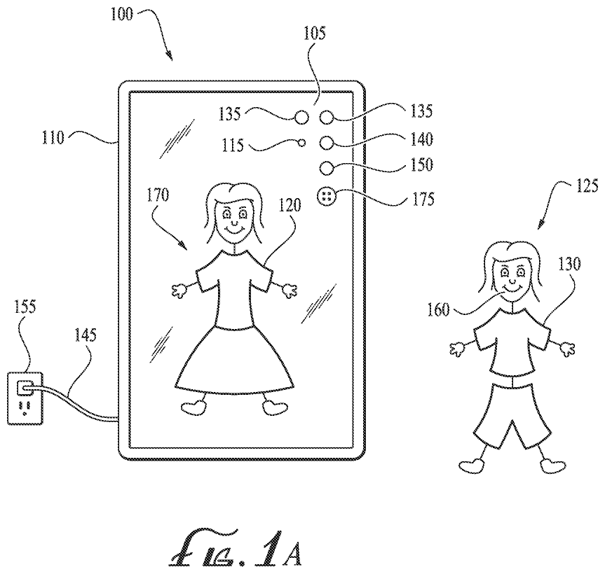

FIG. 1A and FIG. 1B illustrate a front of smart mirror system 100 of illustrative embodiments. Smart mirror system 100 of illustrative embodiments may hang on user's 125 wall or may be mounted on stand 180. Smart mirror system 100 may include computer system 185 (shown in FIG. 1C), traditional mirror 110, computer display 105, speaker 175, microphone 115, one or more cameras 135, motion detector 150, infrared scanner 140 and power cord 145 which may connect to power source 155 such as an AC-DC power outlet. In certain embodiments, power source 155 may be solar panels or batteries. In one or more embodiments computer system 185 may be connected to the internet through an Ethernet, wireless, or other known type of connection to provide the computer with internet access. Computer system 185 may use the internet connection to run software remotely, access one or more databases of information and images, access artificial intelligence software, or run an expert system that may be loaded on the computer system or may be run remotely. Computer system 185 may include image processing software (“computer vision”) capable of identifying user 125 in an image, masking the user's image as the user moves, and displaying overlays of the user on computer display 105. The system may be capable of two-way video or voice communication for interacting other users 125 using cameras 135 and speaker 175. FIG. 1C illustrates an exemplary back of smart mirror system 100 of illustrative embodiments. An exemplary computer system 185 such as a Raspberry Pi or an internet-based cloud server and computer, system power cord 145 and stand 180 may be included. Power cord may connect to power source 155 which may be a battery or AC-DC outlet. Dimensions shown in FIGS. 1A-1C may be exemplary and are not intended to be limiting. User 125 standing in front of smart mirror system 100 may see virtually displayed clothing article 120 on twin reflection 170.

Mirror Display

Computer display film 105, which may be high definition (HD) or Light Emitting Diode (LED) or other such technology, may be incorporated into smart mirror system 100 as a thin membrane which may overlay or underlay the surface of traditional mirror 110. Computer display film 105 may be coupled to computer system 185 so that computer system 185 may control what is displayed on computer display film 105. Computer display film 105 may be transparent or semitransparent. When computer system 185 is off, traditional mirror 110 below computer display film 105 may reflect light in the room as would an ordinary mirror. When computer system 185 is turned on, images and information from computer system 185 may be displayed on computer display film 105. Computer display film 105 of computer system 185 may encompass touch screen functionality to provide the user with one or more selection or other input capabilities. In other embodiments, user 125 may interact with computer display film 105 via voice commands, facial expressions 160, 165, hand motions, an application installed on mobile device 205 and/or other internet enabled device, and/or a dedicated remote control.

Computer system 185 may control at least one camera 135, motion detector 150, at least one speaker 175, and any other devices of smart mirror system 100. Computer system 185 may include software capable of detecting motion coupled with motion detector 150 installed on front of smart mirror system 100. Computer system 185 may include facial recognition software which may enable computer system 185 to identify user 125 standing in front of smart mirror system 100. Using image processing software, computer system 185 may be capable of distinguishing between the image of user 125 and other items visible to camera 135 that may or may not move, such as other people, furniture, pets, doors, curtains, windows or other objects.

Smart Mirror System Customization

During initial program set-up, computer system 185 may gather data to create twin reflection 170 of user 125. Twin reflection 170 may be a to-scale three-dimensional version of user 125 which may be displayed on computer display film 105 of smart mirror system 100. Once uploaded, twin reflection 170 may mimic user 125 movements and position in the way traditional mirror 110 would alone. In some embodiments, user 125 may adjust or change features of twin reflection's 170 appearance. For example, user 125 may be interested in exploring different hair styles or colors. User 125 may temporarily request computer system 185 to alter twin reflection 170 to show such possibilities.

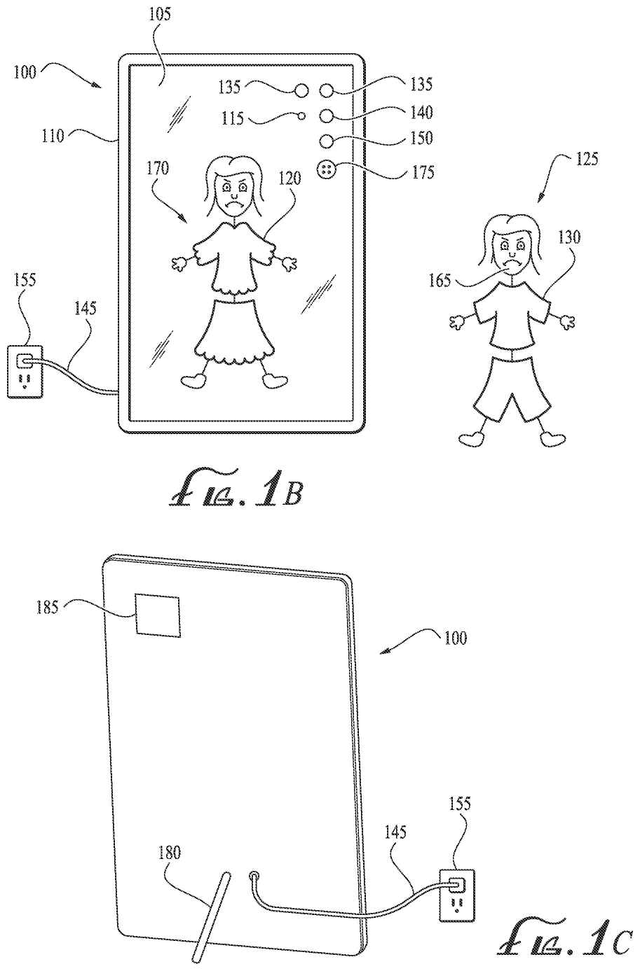

FIG. 2 illustrates a smart mirror set up mode of illustrative embodiments. As seen in FIG. 2, computer display film 105 may prompt user 125 to be dressed in undergarments 200, a bathing suit or other similar clothing and to stand a predetermined distance from smart mirror system 100 to gather data to create twin reflection 170. Computer system 185 may determine user's 125 position relative to smart mirror system 100 using light emitted from camera 135. Computer system 185 may prompt infrared scanner 140 to project measurement grid 210 onto user 125. When the imaging software has identified user 125 in the image, user 125 may be instructed in some embodiments to stand at a particular distance from smart mirror system 100 so that the software can create an image mask to display on computer display film 105. Computer system 185 may prompt user 125 to stand facing camera 135 in anatomical position while projecting measurement grid 210 from infrared scanner 140 onto user 125. User 125 may see an image of user's true reflection in smart mirror system 100. Additionally, computer system 185 may prompt user to present left profile view, right profile view and/or back view to camera while projection grid 210 continues to be projected onto user 125. Computer system 185 may collect and record data regarding user's 125 dimensions using grid 210 projected from infrared scanner 140.

After collecting data to create twin reflection 170, computer system 185 may compare proportions of twin reflection to a database of proportions categorized by body types. Body types in database of proportions may be correlated with styles that may be most flattering on those body types. Computer system 185 may use database of body types to determine body type of user and preferentially select virtually displayed clothing articles 120 that are categorized to be flattering on user's 125 body type. For example, the database may contain proportions correlated to body types such as “pear-shaped”, “apple-shaped”, “hour glass” and/or “rectangular”, for example. Database may correlate body shapes to clothing styles such that, for example, users 125 who are determined to fall into the “hour glass” category may be directed towards clothing suggestions that accentuate the waist. Users 125 who are determined to fall into the “pear shaped” category based on body measurements may be directed towards clothing suggestions with wider neck lines or brightly colored shirts, for example.

During initial set-up of smart mirror system 100, cameras 135 may record data relating to skin tone, eye color or hair color of user 125. Computer system 185 may compare complexion of user 125 to a database of complexions to find a close match. Database of complexions may correlate complexions with clothing colors that are predetermined to be complementary. In some embodiments, computer system 185 may preferentially suggest clothing items to user 125 that are of colors that have been predetermined to compliment the skin tone, eye color and/or hair color of user 125.

Initial set-up may be at least 30-days. During the initial 30 days of use, computer system 185 may remain powered on. Motion detector 150 may detect user 125 when user 125 passes in front of smart mirror system 100. Smart mirror system 100 may use facial recognition software to distinguish user 125 from other people who may pass in front of smart mirror system 100. In some embodiments, smart mirror system 100 may recognize and function for more than one user 125 at the same time. When user 125 is recognized by computer system 185, computer system 185 may record the real-world outfit 130 items being worn by user 125 into a clothing item database for future use. In some embodiments, real-world outfit 130 may be entered into the database of clothing items by holding the item in front of cameras 135. In other embodiments, uploading a digital picture of user 125 wearing real-world outfit 130 to an application associated with smart mirror system 100 may enter the clothing item into the clothing item database. In other embodiments still, a person may hold a printed photograph of user wearing real-world outfit 130 in camera's 135 view in order to enter clothing real-world outfit 130 into the database of clothing items. In some embodiments, the 30-day initial set-up period may be bypassed or shortened.

After completion of the 30-day initial set-up, user 125 may prompt smart mirror system 100 to select and overlay virtually displayed clothing article 120 via computer display film 105 on user's 125 twin reflection 170. Virtually displayed clothing article 120 may be clothing in the clothing item database of computer system 185. In some embodiments, user 125 may input one or more search filters to narrow possible clothing item results. For example, user may filter for only blue clothing and/or only shirts that are short-sleeved.

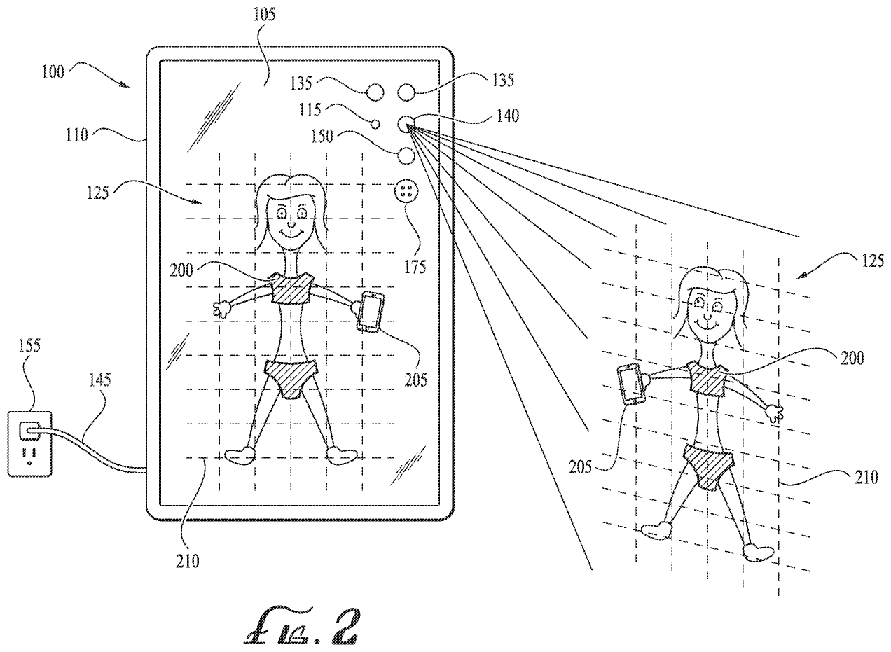

FIG. 3 illustrates the steps user 125 may employ to initiate facial recognition abilities of smart mirror system 100 during set-up mode. In some embodiments, smart mirror system 100 may be controlled by user's 125 facial expressions 160, 165 as in FIG. 1A and FIG. 1B. During initial program set-up process 300, user 125 may install an application on mobile device 205. In some embodiments, initial program set-up may be completed by user 125 on smart mirror system 100 directly. Initial program set-up process 300 may include displaying images to user 125 as in image display step 305 and recording user's 125 response. Displayed images may correlate to a distinctly positive or distinctly negative emotion 165 and computer system 185 and/or mobile device 205 application may be pre-programmed to categorize images as either pleasing or displeasing. For example, the application may display an image of a beach sunset or a beautiful flower in image display step 305, which is categorized by computer system 185 as “positive”. Conversely, the application may display a distinctly displeasing image in image display step 305 which is categorized by computer system 185 as “negative”. For example, displeasing image in image display step 305 may be of rotting food or an injured animal. Image display step 305 may occur on smart mirror system 100 and/or mobile device 205. Images presented in image display step 305 may elicit a strong emotional response from user 125 during emotion step 310. When user 125 sees and interprets a pleasing image in image display step 305, user 125 may have a distinctly positive emotional response as in emotional response step 310. Conversely, when user 125 sees and interprets a distinctly displeasing image, user 125 may have a negative emotional response in emotional response step 310. The emotional response may manifest as a facial expression in expression training step 315 on user 125. Camera 135 on smart mirror system 100 or mobile device 205 may then record the facial expression of user 125 in recording step 320. Computer system 185 may store images of user's 125 reactions. Images of user 125 created after presenting a displeasing image in image display step 305 may be categorized in a database as negative facial expressions. Images of user 125 created after presenting a pleasing image in image display step 305 may be categorized in a database as positive facial expressions. In this way, images may be correlated with either positive or negative emotions 165 in computer program 185 database, as in correlation step 325. This information may be stored in a database correlating facial expressions of user 125 with emotions categorized as either positive or negative as in database input step 330. This process may be repeated in order to capture a wide range of possible facial expressions of user 125 and categorize them as either positive or negative. After sufficient information has been collected, computer system 185 of smart mirror system 100 may identify underlying emotions relating to facial expressions of user 125. In some embodiments, voice recognition features and/or body motions and gestures may function in addition to or in lieu of facial expression recognition features.

Software Functions

Computer system 185 of smart mirror system 100 may be capable of displaying virtually displayed clothing articles 120 for user 125 to “try on” virtually. When user 125 selects one or more items of clothing, computer display film 105 may use imaging software of computer system 185 to create an image of user 125 in virtually displayed clothing article 120. In this way, user 125 may be able to see virtually displayed clothing item 120 selected, sized to fit, on their twin reflection 170 on computer display film 105. Selected clothing item may be from clothing database of user's 125 own clothing. In some embodiments, selected clothing item may be from a clothing vendor database. In some embodiments, user 125 may be prompted to purchase clothing from vendor database if user 125 displays positive emotion 160 after seeing twin reflection 170 in virtually displayed clothing article 120 from vendor database.

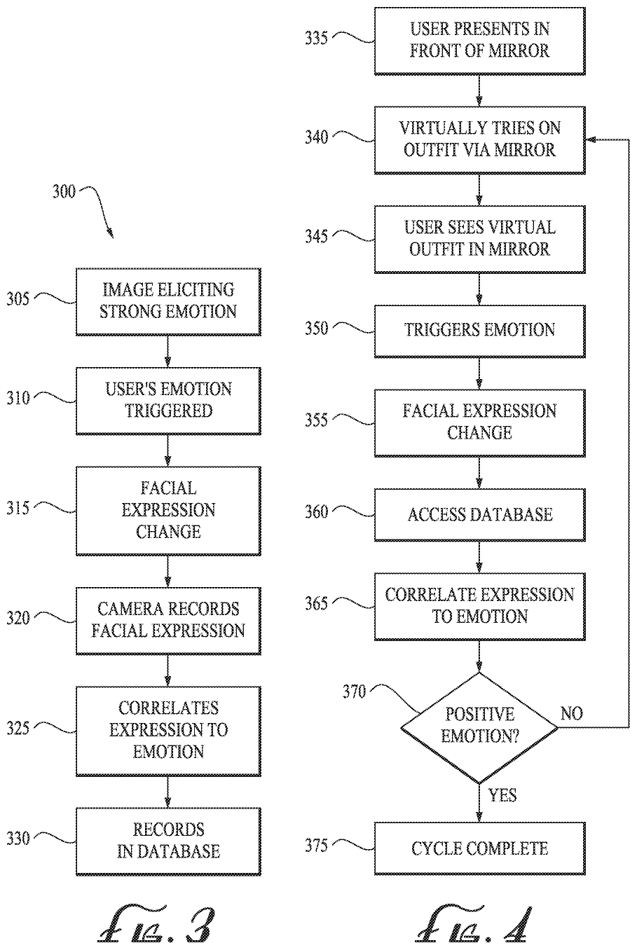

In some embodiments, user 125 may enter search criteria for clothing articles, such as outfits for specific events, of specific colors, or item type. For example, user 125 may search a database for only long-sleeved shirts, wedding guest dresses or only items of clothing that are the color red. FIG. 4 illustrates an exemplary embodiment of the steps carried out by user 125 and computer system 185 during an outfit selection cycle.

In some embodiments, virtually displayed clothing article 120 may be from a clothing vendor database. User 125 may be able to search clothing vendor database to select for desired clothing features such as ecofriendly or naturally-sourced fabrics, diverse brands or small businesses, for example. In some embodiments, user 125 may have the option to make an online purchase of virtually displayed clothing article 120 from vendor. In some embodiments, user 125 may be prompted to visit a traditional shop where virtually displayed clothing article 120 may be purchased in-person. User 125 may search clothing vendor database for specific clothing features such as sustainable fabrics or specific colors. In some embodiments, user 125 may be able to request that a certain virtually displayed clothing article 120 be displayed in an alternative color.

In some embodiments, smart mirror system 100 may be located in a clothing store or be owned by a clothing vendor. In this instance, users 125 may be customers who connect an application on their mobile device to smart mirror system 100 in a clothing shop in order to access their profile and shop the vendor's inventory. In some embodiments, smart mirror system 100 may be coupled directly to the vendor's clothing inventory and may automatically deliver a selected clothing item to user 125 immediately after purchase. In some embodiments, smart mirror system 100 may integrate user's 125 existing wardrobe and real-world outfits 130 with vendor's clothing inventory to create outfits displayed on computer display film 105.

Prior to initiating a scan, the display of smart mirror system 100 of illustrative embodiments may be blank or may display a message. In some embodiments speaker 175 may communicate instructions to user 125, or the instructions may be displayed on computer display film 105. Speaker 175 may also be used for two-way real-time voice or video calling between or among smart mirror systems 100 that are geographically separated. In some embodiments, speaker 175 and microphone 115 may be used to make internet-based phone calls to internet enabled devices such as cellular telephones, tablets or other mobile devices 205. In some embodiments, computer display film 105 may include one or more regions that act as a touch screen for user input to the system.

As computer display film 105 may be a semi-transparent film over traditional mirror 110, traditional mirror 110 may display a reflection of the room in front of smart mirror system 100. When smart mirror system 100 is on, user 125 may see twin reflection 170 of themselves in smart mirror system 100, in the room where they stand, wearing the clothing they have selected from smart mirror system 100. In some embodiments twin reflection 170 may be displayed such that user 125 can move and turn, and virtually displayed clothing article 120 will move and turn with user 125, giving the illusion of a 3-dimensional (3D) image. In some embodiments there may be additional cameras 135 that provide a more detailed image of user 125 from additional angles to enhance the sense of a 3D image.

As is illustrated in FIG. 4, once search parameters are set by user 125 in computer system 185 or in an application associated with smart mirror system 100, user 125 may stand in front of smart mirror system 100 to initiate outfit selection cycle at initiation step 335. User 125 may have the option to select search criteria to limit the possible virtually displayed clothing articles 120 selected by computer system 185. At presentation step 340, smart mirror system 100 may display twin reflection 170 wearing virtually displayed clothing article 120. In presentation step 340, virtually displayed clothing article 120 may be different than user's 125 real-world outfit 130 that user 125 is wearing in that moment. Upon seeing twin reflection 170 displayed on computer display film 105 of smart mirror system 100 at observation Step 345, and at judgement step 350, user 125 may make a personal judgement of their appearance as either positive or negative. User's personal judgement may manifest itself as facial expression correlated with a positive emotion 160 or as facial expression correlated with negative emotion 165 (expression step 355). Computer system may access the database of facial expressions created during initial set-up, as in database reference step 360 and identify the closest match via facial recognition software. Computer system 185 may then correlate the detected facial expression to an emotion in expression-emotion correlation step 365 by referencing facial expressions from the database of user's expressions. If the image is most similar to an image in the database of user 125 that has been associated with a negative emotion, computer system 185 may determine that the facial expression in question represents facial expression correlated to a negative emotion 165 during expression-emotion correlation step 365. If the image is most similar to an image in the database of user 125 that has been associated with positive emotion, then computer system 185 may determine that the facial expression in question represents facial expression correlated to a positive emotion 160. If computer system 185 detects facial expression correlated with negative emotion 165 at emotion inquiry step 370, then computer system 185 may automatically select a different virtually displayed clothing article 120 to present on twin reflection 170 in computer display film 105. If computer system 185 detects facial expression correlated with positive emotion 160 at step 270 then, computer system 185 may pause the search cycle until prompted again by user 125 to begin another search, as in completion step 375. Search prompts initiated by user 125 may be completed directly through smart mirror system 100 or in an application connected to smart mirror system 100.

Another function that may be provided by the AI software of computer system 185 may be to display positive affirmations or messages on computer display film 105 of smart mirror system 100 when user 125 is in proximity of smart mirror system 100. The fashion and style industry may make people, particularly young people, feel inadequate, have negative self-image, harmful thoughts or negative self-talk. A useful feature of smart mirror system 100 of illustrative embodiments may be to display various positive affirmations. Affirmations may have the power to motivate users 125, improve their self-image, and provide positive thinking patterns. In various embodiments smart mirror system 100 may provide daily affirmations from a database of affirmations coupled to the system. Further, the system may provide the ability for others, such as user's 125 parent, for example, to input unique or particular affirmations aimed directly at user 125. For example, computer display film 105 may display, “I will not compare myself to others” one day, and “You are beautiful just the way you are” another day. In addition, users 125 may have the ability to send messages to other smart mirror systems 100 or associated applications of geographically distant users 125, for example, a smartphone app. In some embodiments, computer system 185 may access different affirmations from a database of affirmations depending on the emotion of user 125. Camera 135 may detect facial expressions of user 125 and determine if it is facial expression correlated with positive emotions 160 or facial expression correlated with negative emotions 165. If facial expression correlated with negative emotions 165 is detected, an affirmation may be selected from the database targeted towards negative emotions 165. Such an affirmation may be uplifting. If facial expression correlated with positive emotions 160 is detected, a different set of affirmations from the database of affirmations may be selected from. Such affirmations may offer motivation and/or encouragement for example. In some embodiments, the AI software of computer system 185 track the words user 125 provides to describe their mood and provide appropriate affirmations intended to improve the user's self-image or state of mind. Affirmations may also be provided on a schedule or other basis. Information from the affirmation subsystem may also inform the recommendation portion of the system to build looks to improve the user's feeling or mood. For example, purple clothing may be preferentially selected when user 125 is interpreted by computer system 185 to be presenting with negative emotions 165.

Smart Closet

One problem user 125 may experience is having trouble remembering what is in their closet, and how real-world outfits 130 (and other items in their closet) may be combined to create attractive and stylish outfits that will improve their happiness and self-esteem. Smart mirror system 100 may include a smart closet. During initial set-up, smart closet system 100 may catalog the clothing and accessory items user 125 owns, and display for the user, on request, images of the user wearing various clothing items they already own. Smart mirror system 100, coupled to a database as described above, may scan user 125 wearing outfits and catalog or inventory those outfits in the database. In one or more embodiments computer system 185 may catalog real-world outfits 130 and clothing items thereof. The database may contain or relate a user rating, season, current weight of the user, and current styles and fashions, as selected by user 125. User 125 may search via criteria which may include color, fit, or item type, for example.

The smart closet function of the smart mirror system 100 may use computer vision software to create an image of user 125 wearing the clothing, and storing it so there is no need for user 125 to manually input or enter any data about their closet contents directly into the computer. The smart closet may simply “remember” what it sees when user 125 stands before smart mirror system 100 wearing an outfit. This may be accomplished with computer vision software in combination with the one or more cameras 135 of the system of the invention. This feature of the system allows for “closet mining” and/or “wardrobe mining” to produce outfit suggestions for user 125 that are immediately available. In one or more embodiments this function may be supported by artificial intelligence (AI) software that learns user's 125 preferences and ranks choices using its “learned” knowledge of user preferences. In this way, the smart closet function is an AI closet.

The combined features of smart closet system 100 as discussed herein may have the added benefit of making stylish, flattering suggestions to user 120. As such, smart closet system 100 negates the need for a personal style expert. In some embodiments, a personal style expert may interact with user 120 remotely to suggest or eliminate real-world outfits 130, but smart closet system 100 may function without the input of such an expert.

In some embodiments, smart mirror system 100 may suggest that real-world outfit 130 or individual clothing items in user's 125 closet be discarded or donated if that clothing item has not been selected to be worn within a pre-determined period of time. Period of time before user 125 is prompted to discard clothing may be, for example, one year, two years or five years. In this way, user 125 may avoid clutter by owning a surplus of real-world outfits 130 that user 125 does not wear. In some embodiments, outfits may be designated as sentimental by user 125 in computer system 185. Sentimental clothing items, such as wedding dresses, for example, may be exempt from donation suggestions made by computer system 185.

Smart Closet Extensions

Another feature of the invention may be to create a database that may be maintained over a long time-period, upgraded as time goes on, to produce an “heirloom” product that may be treasured by user 125 and/or user's 125 family. As a young person user 125 may catalog or inventory sentimental real-world outfits 130 such as a prom dress, wedding outfit, quinceañera, holiday or clothing worn for any other special events or occasions over time while owning the product comprising one or more embodiments of the invention. In this way smart mirror system 100 becomes an heirloom, able to display a mother in her early days, for example wearing her prom dress.

The smart closet function may also allow users to store family pictures, images and/or videos of other items that may typically be stored in user's 125 closet. At user's 125 option, one or more embodiments may allow user 125 to use smart mirror system 100 to create a family tree. In one or more embodiments the user may be able to make this family tree public, and link the user with others in their family tree who use smart mirror system 100. This feature may also allow the system to support the user's self-esteem. Smart mirror system 100 may be able to connect to smart mirror system 100 of other users 125 in order to facilitate clothing sharing, photograph sharing, two-way voice calling or two-way video calling. Connecting between or among smart mirror systems 100 of different users 125 may also allow users 125 to share virtually displayed clothing articles 120 to linked smart mirror systems 100 so that friends or family members may share opinions or encouragement about outfits that user 125 may potentially purchase and/or wear.

Thus, a system and method for a smart mirror styling system have been described. Other functions and functional flows of operation may occur in one or more embodiments of the invention. Those described herein are for the purpose of illustration only and do not constitute the invention as a whole.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the scope and range of equivalents as described in the following claims. In addition, it is to be understood that features described herein independently may, in certain embodiments, be combined.

What is claimed is:

1. A method of using a person's image in a smart mirror to recommend stylish clothing items to the person, the method comprising:
creating a multidimensional data mask of a person's image captured from one or more cameras of a smart mirror system;
determining sizing data from the person's body shape and the person's body measurements using the multidimensional data mask;
correlating the sizing data with a subset of clothing item entries in a database associated with the smart mirror system;
inputting the sizing data, the subset of clothing item entries from the database, the person's personal style preference data provided to the smart mirror system, and the data mask into an artificially intelligent (AI) algorithm running on a computer associated with the smart mirror system;
wherein the AI algorithm selects clothing item entries which will best fit the person's size, shape and style, and displays the clothing item entries associated images, scaled dynamically to the multidimensional data mask for display on the smart mirror system such that the display allows the person to virtually try on the clothing items;
interpreting the facial expression of the person to determine the person's opinion of the clothes;
automatically selecting a different clothing item from the entries of clothing items and displaying the clothing item entry's associated images on the data mask to allow the person to virtually try on the clothing item if the facial expression correlates to a negative emotion; and
repeating interpreting and automatically selecting steps until a positive emotion is detected.

2. The method of claim 1 wherein the smart mirror system facilitates a purchase of the clothing item.

3. The method of claim 1 wherein the interpreting the facial expression of the person comprises:
displaying an image that elicits a predicted emotional response from the user;
recording the facial expression associated with that response;
entering the response and correlated emotion into a database of responses;
comparing the person's facial expression during clothing try on to the database of responses; and
identifying the emotion related to that facial expression.

4. A smart mirror system, the system comprising:
a computer;
imaging software running on or associated with the computer;
a touch-enabled smart mirror display coupled to the computer;
one or more front-facing cameras coupled to the imaging software;
a database of clothing items containing image, sizing and style data coupled to the computer;
data about a person's personal preferences regarding clothing available to the computer;
an artificially intelligent learning algorithm able to select clothing items from a subset of clothing items in the database using a best clothing style for the person, the best clothing style based on the person's personal preferences, body shape and body size as determined by the imaging software, and learned best choice styles as proscribed by data.

5. The smart mirror system of claim 3 further comprising:
at least one pre-programmed affirmation;
computer instructions to display the at least one pre-programmed affirmation on the touch-enabled smart-mirror display; and
a user interface providing a means for users to edit the at least one pre-programmed affirmation.

6. The smart mirror system of claim 2 further comprising a smart closet feature comprising:
a database coupled to computer vision system providing an inventory system for creating a set of entries representing all items of clothing, fashion and accessories in a user's closet without requiring the user to input data about their wardrobe.
